(19) United States
(12) Patent Application Publication
(10) Pub. No.: US 2008/0209812 A1
(43) Pub. Date: Sep. 4, 2008

(54) REFRIGERATOR GASKET

(76) Inventors: ARNAUD LANCRY, AUCKLAND (NZ); ADRIAN SARGEANT, QUEENSLAND (AU); SIMON ALBRECHT, QUEENSLAND (AU)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 12/019,354

(22) Filed: Jan. 24, 2008

Related U.S. Application Data
(60) Provisional application No. 60/886,691, filed on Jan. 26, 2007.

(51) Int. Cl. E06B 7/28; F16J 15/53

(52) U.S. Cl. 49/316; 277/402

(57) ABSTRACT

The invention relates to an improved gasket for a French door type refrigerator including a rotating mullion. The improved gasket reduces condensation around the area at the top and bottom of the rotating mullion and the gap between the mullion and cabinet. The gaskets located on the inner periphery of die doors are provided with tabs to seal the gap. An additional magnetic element is provided on the tabs to improve sealing and the thermal properties of the tab seals to alleviate the formation of condensate in this critical area.

### BACKGROUND OF THE INVENTION

1. Field of the Invention

The present invention relates to improved gaskets for refrigerators and more particularly to improved gaskets for French door type refrigerators including a moving mullion.

2. Discussion of the Prior Art

French door refrigerators are known in the art as a term commonly used to describe a side-by-side double door refrigerator or freezer such as that shown in FIG. 1. Such double door configurations have the advantage that two doors instead of one, are used to seal or close the front of die refrigerator and/or freezer cabinet. The use of two doors allows each door to be approximately half die size and weight when compared to a single door spanning the entire width of the appliance cabinet. This allows adequate access to the refrigerator/freezer compartments without requiring an overly large door that would swing open a greater distance into the users' kitchen space. Usually, this configuration is used for side by side refrigerators. It will be understood though, that the present invention and may be utilised with double door freezers as well. The general descriptive term French door refrigerator has been used for convenience sake only to denote the double door configuration illustrated generally in. FIG. 1.

In such a double door configuration, it is necessary to seal die gap between the doors in order to prevent cold air leaking out of the refrigerated space which may compromise performance. It is desirable that the seal configuration between the doors does not constrain the user to a particular order in which the side-by-side doors need to be opened and/or closed. It is also desirable that the seals do not unduly increase the force required to open or close the doors. If the force required to close the doors properly is too high, then proper sealing may not be achieved if the user does not close the door-hard enough.

One style of double door refrigerator also comprises a single, refrigerated compartment closed by two side-by-side French doors. One method of sealing the gap or space between side-by-side doors is to provide a gasket arrangement which extends across and closes the gap between the doors. An example of this type of solution is U.S. Pat. No. 3,942,853. This type of arrangement may adversely affect the opening/closing of the doors.

Another style of double door (French door) refrigerator includes a central mullion dividing the refrigerated space into two compartments. In this configuration each of the double doors functions to close and seal the respective side-by-side compartments. The central dividing mullion provides a sealing face on die front side of die cabinet (between the doors) which allows the gaskets on the inner edges of the doors to seal in a conventional manner. However, the dividing mullion has a drawback in that it reduces the users' access to the compartments and reduces the efficiency and usability of the storage space.

Another known solution, is to provide a moving mullion attached to one door which moves into a sealing position when the doors ate closed and moves out of the way when the door(s) are open. One such solution provides a pivoting or rotating mullion attached to one of the doors. An example of this configuration is described in U.S. Pat. No. 7,008,032 to Chekal. FIGS. 2-6 are from Chekal which describes die basic operation of a rotating mullion solution as follows:
Reference will now be made to FIGS. 2-6, which have been presented without a gasket for clarity of the drawings, in describing an example method of operation. Mullion bar 148 is adapted to rotate about first and second hinge, members 206 and 207 (not shown). Toward that end, guide pin 190 travels through a guide path 260 provided in guide element 22 when door member 28 is opened or closed. As shown, guide path 260 includes a first sloping portion 262 extending to a substantially straight segment 264 followed by a curved portion 266 and terminating in an in-turned portion or projection 267. As further shown in FIG. 2, guide pin 190 is provided with a first cam surface 280 which is adapted to engage guide path 260 when door member 28 is closed and a second cam surface 285 which is adapted to engage projection 267 when door member 28 is opened. With this arrangement, it should be understood that door member 28 could be opened irrespective of the position of door member 29.
In any event, when door member 28 is in a closed position as shown in FIGS. 2 and 3, second cam surface 285 of guide pin 190 rests against projection 267 of guide element 22. With initial movement of door member 28 to the position shown in FIG. 4, guide pin 190 is forced against projection 267 causing mullion bar 148 to gradually begin to rotate relative to door member 28. As door member 28 continues to open as shown in FIG. 5, second cam surface 285 of guide pin 190 begins to travel along projection 267 causing mullion bar 148 to further rotate relative to door member 28. Preferably the mullion bar 148 is biased to rotate away from its initial position when the door is closed. This serves to keep the mullion out of the way when the door 28 is closed avoiding clashing with the other door 29.
In the example embodiment, mullion bar 148 rotates approximately 110° between its two end positions. Mullion bar 148 will remain in this position until door member 28 is closed causing first cam surface 280 to travel along guide path 260 so as to rotate mullion bar 148 to the sealed position shown in FIG. 2. With this construction, door member 28 can be opened and closed without having to operate door member 29, while still enabling the gasket of door member 29 to seal against mullion bar 148. In this manner, the likelihood that a door will be left ajar is reduced. The rotating mullion bar may also require less opening force for the door that a traditional gasket due to the way in which the seal is broken during relative movement of the rotating mullion and the gasket 14.)
It will be appreciated that the purpose of the above example, embodiment is to describe one method of implementing a rotating mullion bar type solution to sealing the gap between a double door refrigerator. Other variants are also known in die art which include minor variations to the shapes of the mullion guide pin and cabinet guide as well as varying methods of biasing the mullion bar.

With reference to FIGS. 1 & 10, the common general features of refrigerator 13 are; when the door 1 carrying the rotating mullion 3 is closed, the mullion bar 3 is rotated via a guide (generally referred to as mullion guide 5), into its first position to provide a sealing surface 8, flush with the front face 6 of the cabinet. When in this position, traditional style refrigerator door gaskets 14 located on the inner edge of the door, seal the compartment. As the door carrying the rotating mullion is opened, the mullion 3 is rotated into its second position by the guide 5, where it is moved out of the way of the other door 2 so that it does not contact it as it is opened.

As shown in FIG. 1, the opening and closing of door 2 proceeds in a normal fashion. The mullion bar 3 also provides a sealing surface 8 in substantially the same plane as the cabinet face 6 for the gaskets located on the outer edge of the inner surface of door 2 to seal against. Opening and closing of door 2 does not require rotation of the mullion bar 3 between its first and second positions.

While the rotating mullion configuration described above is desirable for the purpose of improving access to the refrigerated space, this solution raises other technical difficulties especially in regard to condensation around the sealing surfaces. A further problematic area of this rotating mullion bar arrangement is leaking through die clearance gap 7 between the top of the mullion bar 3 and the guide 5. Any leakage will significantly reduce the energy performance of the appliance requiring the compressor to run longer. Similarly, the bottom of the mullion bar may also have a gap (and may also include a guide element 5), which may lead to the same leaking or condensation problems. Several attempts have been made to minimise this gap 7. For example, in JP 02122191, a moveable (translating) rubber seal is provided on the end of mullion bar 3 which ‘wipes’ against the guide in order to effect a better seal. One disadvantage of this solution is an increased opening/closing force required to open the door.

Referring to FIG. 1, another method of sealing the gap 7 between the mullion bar 3 and the guide 5, is to provide a thin tab of gasket material 9 which extends from die main gasket located on the inner periphery of die doors. The tabs 9 are located on the top and bottom of each door so that they span the gap 7 as shown in more detail in FIG. 10. The tabs 9 are arranged so that they sit flush against die face of the mullion bar 8 and the face of cabinet 6. The tabs on the upper edge of respective doors are preferably arranged so they overlap when both doors are in a closed position. It is preferable that the tabs are thin and flexible to allow either door to be opened or closed in any sequence.

Referring to FIGS. 1 & 10, door 1 is shown closed and the tab 9 is located adjacent the sealing surfaces 6, 8 of the cabinet and mullion bar respectively. As door 2 is closed, the tab at the upper surface of door 2 seals over top of the tab 9 on door 1. If door 1 is subsequently opened (with door 2 still closed), the tabs are sufficiently flexible that the tabs on door 2 do not interfere with the opening of door 1. In order to provide adequate sealing, the tabs need to be thin to accommodate the alternating overlapping patterns resulting when each of the doors 1 and 2 are opened and closed in different sequences. However, it has been found that such a design can result in insufficient sealing due to folding or deforming or ripping of die thin fragile tabs. Also failure of the tabs after a time due to wear and fatigue or misuse is common. A more robust and effective solution is desirable as failure can result in significant leakage or expensive repair becoming necessary.

This area between the top of the mullion bar 3 and the guide 5 (shown in FIG. 10) is particularly problematic for sealing and condensation, because it is in a direct path with the cold air within the refrigerated space Further, any leakage of cold air in this region can cool the edge 12 of the door m the vicinity of the gap 7, leading to condensation forming on the door skin. One method of alleviating this condensation is to heat the affected areas and/or sealing faces 6 of the cabinet with a “throat heater”. Similarly, the front face 8 of the mullion bar 3 may also be heated to reduce condensation forming as relatively warm humid air comes in contact with the cold surface (when the face is not heated). However, it is highly desirable to eliminate or at least limit the amount of heating required because of the significant detrimental effect on the appliance's energy consumption.

It is also technically difficult to provide a heater to the face 8 of the mullion bar 3 due to it being a moveable member. Even if the refrigerator does include a heater, it: is difficult to completely eliminate condensation due to the fact that the throat heater(s) in the cabinet face cannot extend all the way across die gap 7. Similarly, because, the rotating mullion bar 3 is moveable, a throat heater on the mullion bar 8 also cannot extend all the way across the gap. One way of heating the problematic area around the top of the mullion bar 3 and the guide 5 is to include more powerful heaters around these zones and rely on the conduction of heat to the surfaces that form the gap 7. However, it may also be desirable to fabricate at least the top of the mullion bar 3 and/or the guide 5 from a plastic material which, has a relatively low thermal conductivity. This material property further frustrates prior art attempts to use a throat heater effectively in this area.

Further, while throat heaters do function to alleviate condensation in this problem area, it is not especially desirable to heat areas of a refrigerator due to the detrimental effect to the energy efficiency of the refrigerator appliance. Energy efficiency is a feature that is becoming increasingly important. It is an object of the present invention to provide an improved gasket arrangement which goes at least someway to alleviating some of the problems described above, or to at least provide the public with a useful choice.

### SUMMARY OF INVENTION

In a first aspect the present invention consists in a refrigerator comprising:
a cabinet including a compartment having an open front, said open front having a peripheral front edge,
first and second French-style doors rotatably mounted to said cabinet to substantially close said open front of said compartment, said first and second doors having a narrow gap between when said doors are closed,
at least one guide mounted to one of upper or lower portions of said compartment,
a rotating mullion bar mounted on said first door, wherein said rotating mullion is rotated by
said at least one guide to a first position when said first door is closed, said first position such that said mullion bar extends beyond an inner edge of said first door and spans the expected position of said narrow gap to substantially cover said gap when said first door and said second door are closed,
said first and second doors having gaskets around the periphery of the inner face of each said door, to seal with said peripheral front edge of said cabinet and a scaling face of said mullion, to substantially seal said gap,
said door gaskets including upper and lower tabs extending from the periphery of said gasket across said gap between said doors and spanning a clearance gap between said mullion bar and said compartment, when said doors are closed,
each of said tabs including a magnetic element, said magnetic elements urging said tab against said front edge and said mullion bar to seal said clearance gap.

Preferably said mullion bar is biased into a second position relative to said first door wherein in said second position said mullion is rotated away from said first position such that said mullion does not extend substantially beyond said inner edge of said first door.

Preferably said tabs are thin flexible polymer material and integrally formed with said door gaskets.

Preferably said magnetic elements are thin planar strips of magnetic material orientated substantially parallel to the plane of said inner face of said respective doors.

Preferably said magnetic elements are located on the inside surface of said tabs such that said elements contact said front edge of said compartment and said mullion bar directly when said respective door is the first closed.

Preferably at least one of said mullion bar or said front edge of said compartment includes a heater, and said magnetic element rests adjacent said at least one of said mullion bar or said front edge of said cabinet, and conducts heat from said heater to raise the temperature of said element.

Preferably said magnetic elements are located on the outside of said respective tabs.

Preferably said tabs include a pocket and said magnetic element is located substantially within said pocket.

Preferably said magnetic elements are encapsulated within said tabs.

Preferably said magnetic elements are co-extruded and include magnetic and non-magnetic material with a central band of non-magnetic material located at the expected location of said clearance gap when said respective door is in a closed position.

Preferably said tabs include magnetic and non-magnetic material and include a central band of non-magnetic material located at the expected location of said clearance gap when said respective door is in a closed position.

Preferably said tabs are thin flexible polymer material.

Preferably said tabs are integrally formed with said door gaskets.

Preferably said magnetic elements are thin strips of magnetic material.

Alternatively said magnetic elements are located on the outside of said tabs such that said element absorbs heat energy from the surrounding ambient air.

In a further aspect the invention consists in an improved double French door refrigerator gasket comprising:
a substantially rectangular main gasket,
upper and lower tabs extending from the outer periphery of said gasket, each said tab including a thin substantially planar magnetic element.

Preferably said tabs are thin and flexible and integrally formed with said main gasket.

Preferably said magnetic elements are located on the inside surface of said tabs.

Preferably said magnetic elements are located on the outside surface of said tabs.

Preferably said tabs include a pocket and said magnetic element is located within said pocket.

Preferably said magnetic elements are co-extruded and include magnetic and non-magnetic material with a central band of non-magnetic material.

Preferably said magnetic elements are encapsulated within said tabs

Preferably said tabs are thin flexible polymer material.

Preferably said magnetic strips are adhesively fastened to said tabs.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

Preferred forms on the present invention will now be described with reference to the accompanying drawings in which,

FIG. 1 is a perspective view of a prior art French door refrigerator.

FIG. 2 is a cross-sectional drawing of a prior art refrigerator having a rotating mullion.

FIG. 3 is a cross-sectional drawing of a prior art refrigerator having a rotating mullion, shown with the doors closed.

FIG. 4 is a cross-sectional drawing of a prior art refrigerator having a rotating mullion, shown with a door slightly open.

FIG. 5 is a cross-sectional drawing of a prior art refrigerator having a rotating mullion, showing the rotation of the mullion bar as the door opens.

FIG. 6 is a cross-sectional drawing of a prior art refrigerator having a rotating mullion, showing the rotation of the mullion bar as the door further than shown in FIG. 5.

FIG. 7 is a perspective cut away view of an improved refrigerator gasket according to an embodiment of the present invention.

FIG. 8 is a perspective cut away view of an improved refrigerator gasket according to another embodiment of the present invention.

FIG. 9 is a perspective cut away view of an improved refrigerator gasket according to yet another embodiment of the present invention.

FIG. 10 is a close-up view of the refrigerator gasket area indicated in FIG. 1.

FIG. 11 is a perspective cut away view of an improved refrigerator gasket according to still another embodiment of the present invention.

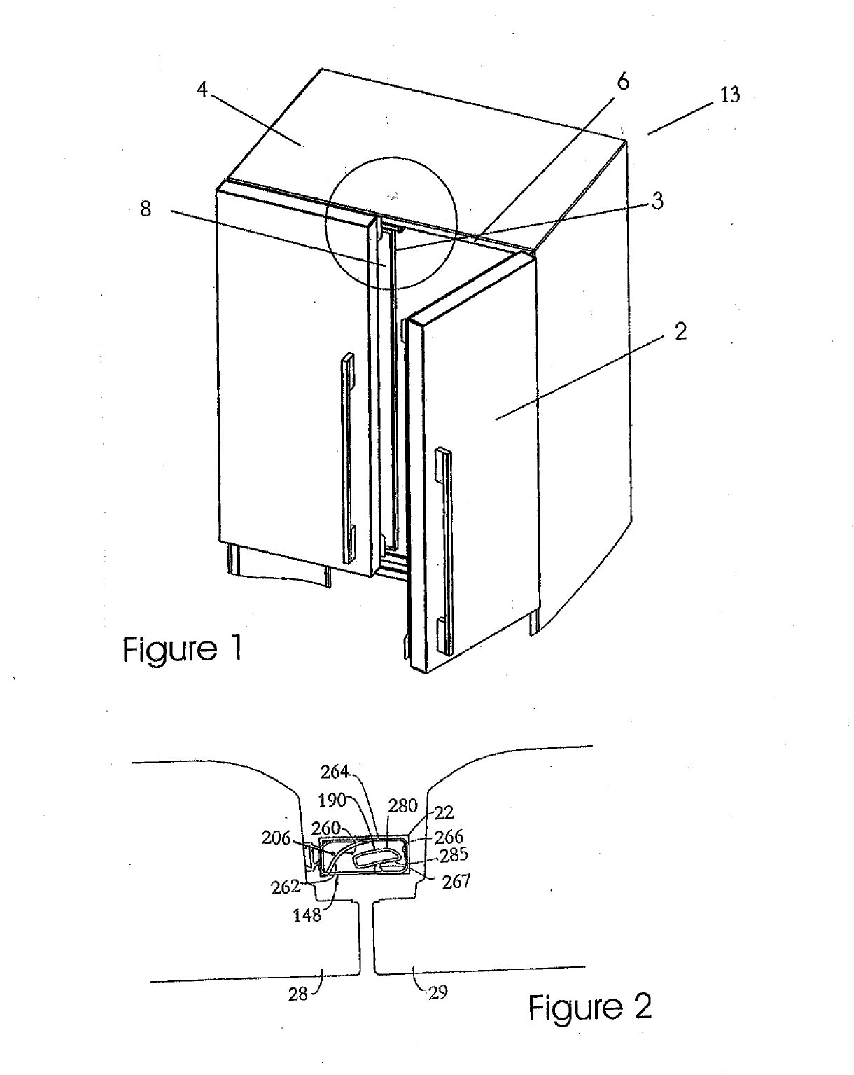

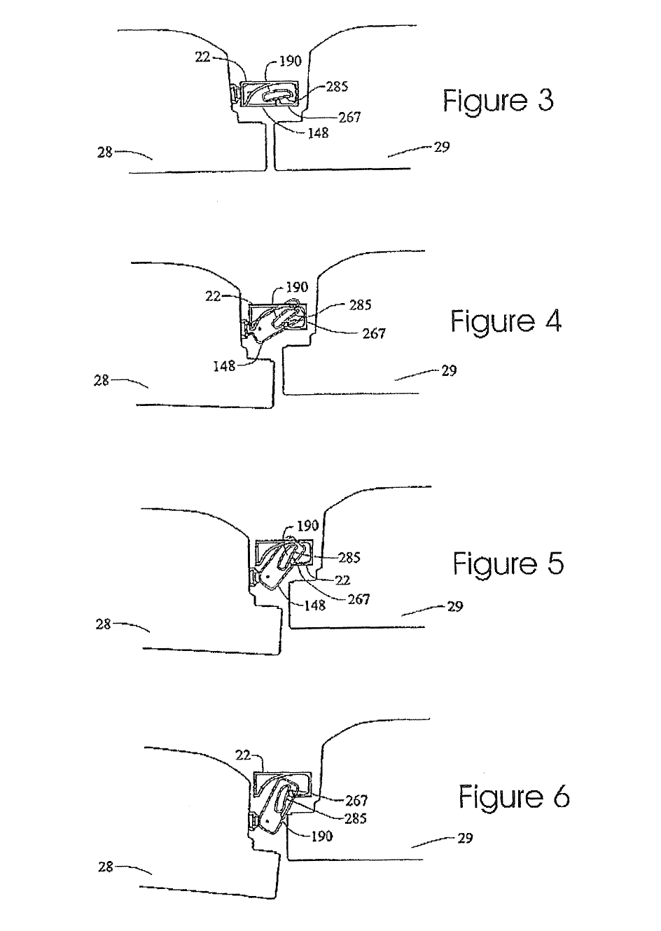

### DETAILED DESCRIPTION

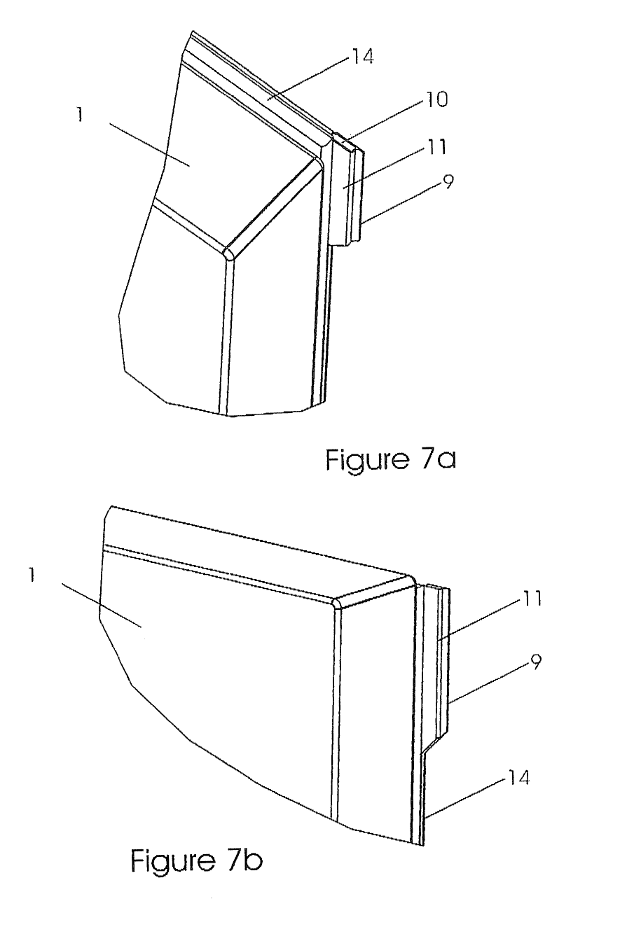

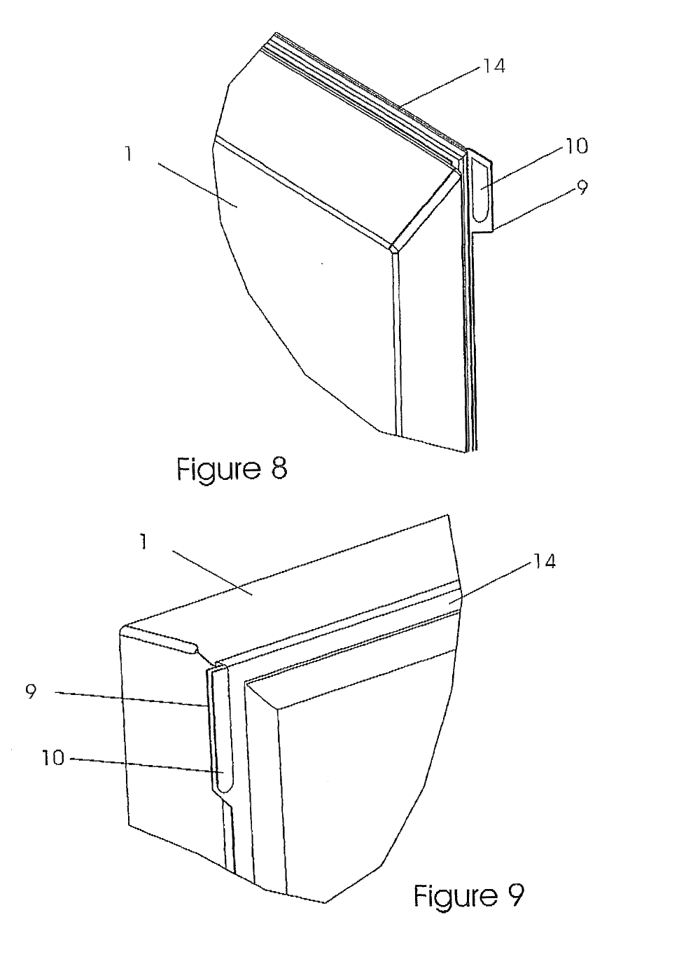

Preferred embodiments of the invention will now be described particularly with reference to FIGS. 7 to 11.

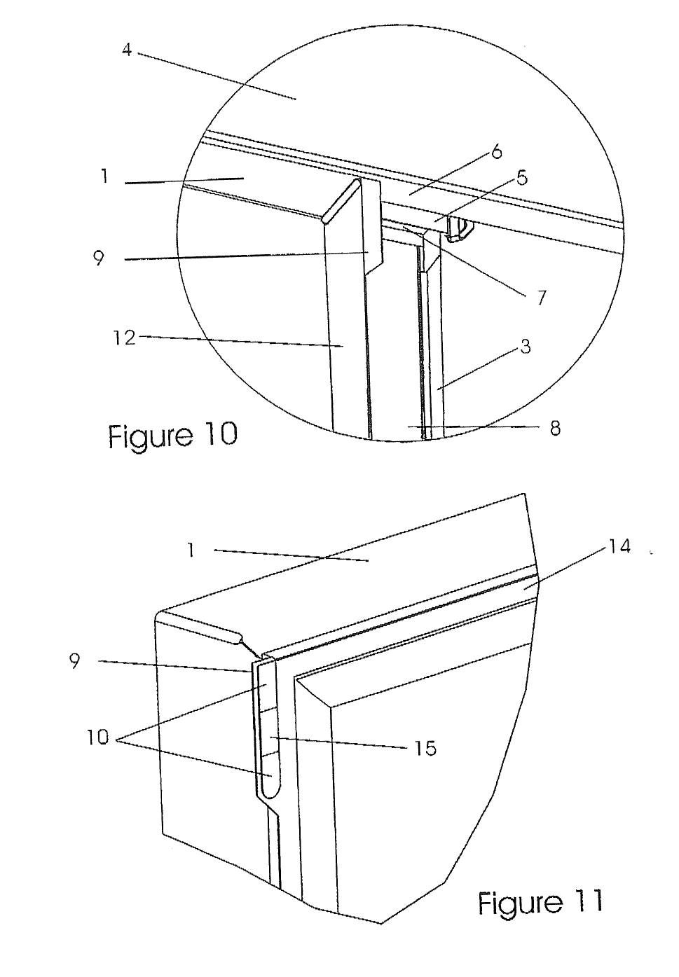

Referring to FIG. 9, a section of a refrigerated door is shown having a gasket 14 located on die inner periphery. Gasket tab 9 extends from door gasket 14 in order to seal clearance gap 7 between the cabinet and the top of the mullion bar as illustrated generally in FIG. 10. An additional magnetic element 10 is provided on the inner surface of tab 9. Preferably the element 10 is fastened to the tab by suitable adhesive. Alternatively, the element 10 can be integrally formed with said tabs.

For this arrangement, when the door 1 is closed (before the second door), magnetic element 10 is attracted to, and contacts, die cabinet face 6 and mullion sealing face 8. Preferably both surfaces 6 and 8 are of a ferro-magnetic material for this purpose (i.e. a metallic cabinet which might also be coated for example). As noted earlier, it is important that the overall thickness of tab 9 (including magnetic element 10) remains low in order to allow an adequate seal between the overlapping tabs of adjacent closed doors 1 and 2. In this respect it has been previously necessary to keep die thickness of the tab as low as possible. The magnet 10 serves to provide the tab 9 with additional sealing strength due to the attraction of the magnet to the metallic sealing faces 6 and 8. Due to the over-lapping interaction of tabs 9 from adjacent doors as they are opened, the tabs need to remain flexible enough to prevent damage but the magnetic element provides a degree of reinforcement to improve the life of the seal as-well as improving the effectiveness. The overlapping arrangement may also help to seal the outer tab (of door 2) onto the outer surface of tab 9 (on door 1 as shown in FIG. 10). In this regard, the potential detriment of the additional lab thickness can be offset by the additional magnetic attraction (between magnetic elements 10 on respective overlapping tabs 9) to provide adequate leak-free sealing and improved life and durability.

It has been found during testing that the mullion bar 3 may contact the tab 9 (on door 2) when the door 1 is closing as the mullion bar 3 rotates into its sealing position as shown in FIG. 10. This contact urges the tab on door 2 away from the ideal sealing orientation parallel with the respective sealing faces 6 and 8 as shown in FIG. 10. This contact may lead to permanent deformation of die tabs 9 (especially on door 2) which may reduce effectiveness. It has been found that after many cycles of opening and closing, the tab 9 may fail to adequately seal due to defamation of the tab which prevents it from springing back after it has been bumped by the mullion bar as the door 1 closes. The magnetic element 10 helps to prolong the life of the seal in this respect as it provides an additional ‘spring back’ type force to maintain a proper seal of the gap 7 in this critical region. The overall effect is to improve the sealing, thus improving the appliance's energy efficiency, and alleviating condensation.

It has also been found that the magnetic element 10 has an additional desirable effect due to the thermal conductivity of the magnetic element. Refrigerator gaskets are typically fabricated from a plastic material with a low thermal conductivity such as PVC. The magnetic element 10 provides a bridge across the sealing faces 6 and 8 of a material with a relatively high thermal conductivity (when compared to the PVC gasket). With this configuration, heat from a throat heater located in face 6 of die cabinet and/or face 8 of the mullion bar 3 is conducted along the magnetic element. This raises the temperature of the outside surface of the tab 9 (which is in contact with ambient air) thus reducing the potential for condensate formation. This construction is an effective method of slightly heating this critical area around the gap 7 between the top of rotating mullion bar 3 and the cabinet/guide 5. Previous solutions to heat the top of die mullion bar, cabinet and/or the guide 5, have been significantly more complicated and thus expensive. The present solution provides additional heat to the most critical area, while still allowing the top of the mullion bar and the guide etc to be manufactured from a preferred polymer material.

Referring to FIG. 8, door 1 is shown with gasket 14 and tab 9. In this alternative embodiment, a magnetic element 10 is located on die outside surface of tab 9, In a similar manner to the previous embodiment, the magnet 10 provides a better seal due to the attraction of the magnet to the metallic sealing faces 6 and 8. In this embodiment there is die thin polymer layer of the gasket tab 9 between the magnet and the respective sealing faces 6 and 8 which insulates the magnetic element from die cold air gap 7. This additional layer requires a more powerful magnet able to act through the intermediate layer. This may result in a thicker magnetic element 10 being required. In this embodiment some heat may be conducted through the polymer tab 9 from a throat heater (if present) heating the magnetic element 10. Whether or not a throat heater is present in sealing surfaces 6 or 8, the magnetic element 10 acts as a thermal heat sink drawing energy from the warm ambient air. This raises its temperature, which may act to alleviate condensation on its outer surface.

Referring now to FIG. 7, another alternative embodiment is shown. In this embodiment, door 1 is provided with a gasket 14 and a similar tab 9 extending therefrom. In this embodiment magnetic element 10 is embedded in pocket 11 of tab 9. This embodiment provides the same unproved sealing of the magnetic element while also encapsulating the magnet in a thin layer of polymer. On the inner surface which seals against respective faces 6 and 8, the polymer layer provides a softer material buffer which may reduce wear against the sealing faces (which may be painted or otherwise coated) as well as provide some insulation between the element and the cold air gap 7. On the outer surface, the encapsulating polymer layer hides the embedded magnet and may improve the aesthetic appearance of tab 9.

In a similar manner to the previous embodiments, magnetic element 10 acts as a heat sink drawing energy from the ambient air surrounding the appliance and/or from any throat heater present in the cabinet face 6 or the mullion bar 8. In this way the magnetic element not only improves the sealing and the life of the seal, but also provides a solution to deliver additional heat to the critical area in order to further reduce condensation. Importantly, the heat sink drawing energy from the ambient air results in less energy being required from the throat heaters. Accordingly, a lower power throat, heater can be used, which in turn improves the appliance's thermal and energy efficiency.

Referring to FIG. 11 a further embodiment is shown. In this embodiment magnetic element 10 includes a band of non-magnetic material in the middle. The non-magnetic region 15 is located to be adjacent gap 7 when the door 1 is closed and the tab 9 seals against faces 6 and 8 respectively. The outer magnetic elements 10 are positioned to abut, and attract to, faces 6 and 8 respectively. A preferred method of manufacturing magnetic element 10 (including non-magnetic element 15) for this embodiment is to co-extrude in a strip having three parallel regions. The strip has outer magnetic material and an inner band of non-magnetic material, which can be cut into banded elements 10. Methods of co-extruding magnetic materials into a polymer base are known in the art and would be understood by a skilled person.

In this embodiment the central region of polymer material 15 has a relatively low thermal conductivity. As this region provides the seal over gap 7 it is exposed to the cold air within the refrigerator cabinet. The added thickness of thermally insulating material in this region provides an increased thermal resistance. The polymer band 15 thereby insulates the outer face of tab 9, adjacent the gap 7, from the cold inner surface which is in contact with the refrigerated space. The effect is to thereby reduce the potential for condensation forming on the critical outer surface of tab 9. In the absence of any throat heaters, it may be preferable to insulate the region 15 adjacent the cold air within the cabinet, as there will be no heat conducted from the throat heater.

All the above described embodiments provide a relatively cheap method of reducing the formation of condensate in the critical region between the rotating mullion and the cabinet. These embodiments also improve the sealing effectiveness and life of the tabs which seal gap 7.

1. A refrigerator comprising:
a cabinet including a compartment having an open front, said open front having a peripheral front edge,
first and second French-style doors rotatably mounted to said cabinet to substantially close said open front of said compartment, said first and second doors having a narrow gap between when said doors are closed,
at least one guide mounted to one of upper or lower portions of said compartment,
a rotating mullion bar mounted on said first door, wherein said rotating mullion is rotated by said at least one guide to a first position when said first door is closed,
said first position such that said mullion bar extends beyond an inner edge of said first door and spans the expected position of said narrow gap to substantially cover said gap when said first door and said second door are closed,
said first and second doors having gaskets around the periphery of the inner face of each said door, to seal with said peripheral front edge of said cabinet and a sealing face of said mullion, to substantially seal said gap,
said door gaskets including upper and lower tabs extending from the periphery of said gasket across said gap between said doors and spanning a clearance gap between said mullion bar and said compartment, when said doors are closed,
each of said tabs including a magnetic element, said magnetic elements urging said tab against said front edge and said mullion bat to seal said clearance gap.

2. A refrigerator as claimed in claim 1, wherein said mullion bar is biased into a second position relative to said first door wherein in said second position said mullion is rotated away from said first position such that said mullion does not extend substantially beyond said inner edge of said first door.

3. A refrigerator as claimed in claim 1 wherein said tabs are thin flexible polymer material and integrally formed with said door gaskets.

4. A refrigerator as claimed in claim 1 wherein said magnetic elements are thin planar strips of magnetic material orientated substantially parallel to the plane of said inner face of said respective doors.

5. A refrigerator as claimed in claim 1 wherein said magnetic elements are located on the inside surface of said tabs such that said elements contact said front edge of said compartment and said mullion bar directly when said respective door is the first closed.

6. A refrigerator as claimed in claim 5, wherein at least one of said mullion bar or said front edge of said compartment includes a heater, and said magnetic element rests adjacent said at least one of said mullion bar or said front edge of said cabinet, and conducts heat from said heater to raise the temperature of said element.

7. A refrigerator as claimed in claim 1 wherein said magnetic elements are located on the outside of said respective tabs.

8. A refrigerator as claimed in claim 1 wherein said tabs include a pocket and said magnetic element is located substantially within said pocket.

9. A refrigerator as claimed in claim 1 wherein said magnetic elements are encapsulated within said tabs.

10. A refrigerator as claimed in claim 1 wherein said magnetic elements are co-extruded and include magnetic and non-magnetic material with a central band of non-magnetic material located at the expected location of said clearance gap when said respective door is in a closed position.

11. A refrigerator as claimed in claim 9, wherein said tabs include magnetic and non-magnetic material and include a central band of non-magnetic material located at the expected location of said clearance, gap when said respective door is in a closed position.

12. An improved refrigerator gasket comprising:
a substantially rectangular main gasket,
upper and lower tabs extending from the outer periphery of said gasket, each said tab including a thin substantially planar magnetic element.

13. An improved refrigerator gasket as claimed in claim 12, wherein said tabs are thin and flexible and integrally formed with said main gasket.

14. An improved refrigerator gasket as claimed in claim 12 wherein said magnetic elements are located on the inside, surface of said tabs.

15. An improved refrigerator gasket as claimed in claim 12 wherein said magnetic elements are located on the outside surface of said tabs.

16. An improved refrigerator gasket as claimed in claim 12 wherein said tabs include a pocket and said magnetic element is located within said pocket.

17. An improved refrigerator gasket as claimed in claim 12 wherein said magnetic elements are co-extruded and include magnetic and non-magnetic material with a central band of non-magnetic material.

18. An improved refrigerator gasket as claimed in claim 12 wherein said magnetic elements are encapsulated within said tabs.
